(19) United States
(12) Patent Application Publication
(10) Pub. No.: US 2026/0355846 A1
(43) Pub. Date: Nov. 12, 2026

(54) PRESSURE FIXTURE ASSEMBLY INCLUDING AN EXPANSIBLE BELLOWS FOR DIFFUSION BONDING

(71) Applicant: ACS Industries, Inc., Lincoln, RI (US)

(72) Inventors: George Greenwood, Tiverton, RI (US); Timothy Davenport, Cumberland, RI (US)

(73) Assignee: ACS Industries, Inc., Lincoln, RI (US)

(21) Appl. No.: 19/562,219

(22) Filed: Mar. 10, 2026

Related U.S. Application Data
(60) Provisional application No. 63/769,569, filed on Mar. 10, 2025.

(51) Int. Cl. B23K 20/02

(52) U.S. Cl. CPC B23K 20/023

(57) ABSTRACT

A pressure fixture assembly for diffusion bonding includes a pressure fixture frame and an expansible bellows assembly in the place of expansion wedges to both increase the available space within the pressure fixture frame for product to be bonded and to more precisely control the applied pressure through all phases of heating and cooling. The fixture frame may be constructed out of graphite, consisting of side wall plates, a top and bottom plate, and a float plate. The bellows assembly comprises a base plate and one or more high-temperature cylindrical bellows on the base plate, each bellows comprising an extendable bellows wall and a cylindrical end cap. The bellows assembly components may be made of Inconel 625 which becomes pliable at temperature above 1000 °F wherein the bellows can be extended at temperatures >1000 °F using high pressure Argon gas.

### CROSS-REFERENCE TO RELATED APPLICATIONS

This application is a non-provisional filing of, and claims the benefit of, U.S. Provisional Patent Application No. 63/769,569, filed Mar. 10, 2025, the entire contents of which is incorporated herein by reference.

### BACKGROUND OF THE DISCLOSURE

### (1) Field of the Invention

The instant invention generally relates to diffusion bonding of metals in a vacuum furnace, and more particularly to a pressure fixture assembly for use in fixturing and applying pressure to stacked layers of material for bonding.

### (2) Description of Related Art

The process of diffusion bonding is a solid-state joining process that occurs at high temperature and pressure for a controlled amount of time. Diffusion bonding is unique from other joining processes in that the principal mechanism is interdiffusion of atoms across the joining interfaces. In a good diffusion bond, grains grow across the bonding surfaces until the bonded pieces no longer have an identifiable bond line and the strength of the bond is equivalent to the parent metal.

In the context of the present disclosure, diffusion bonding is practiced in a vacuum furnace with a controlled temperature profile to bond stacked layers of expanded metal mesh for various industrial applications. In the exemplary prior art process, the pressure required for diffusion bonding is created by thermal expansion of wedges with a higher coefficient of thermal expansion (CTE) fixed within a lower CTE pressure fixture.

More specifically, stacked layers of material to be bonded are placed in the pressure fixture wherein they expand on heating (see FIG. 1). The expansion of the material in the fixture is limited by the relatively lower expansion of the fixture housing causing the material to press against the fixture walls. Pressure control is achieved by using two different kinds of materials within the fixture with different CTEs, namely pressure wedges typically made of stainless steel and the stacked metal layers to be bonded packed tightly at room temperature into the fixture.

Separating plates of a nonbonding material may be used to separate individual stacks of metal layers, preventing bonding between individual stacked layer assemblies. By varying the ratio of the lengths of materials with differing CTEs in the tightly packed dimension within the fixture, the pressure experienced can be precisely controlled.

### SUMMARY OF THE DISCLOSURE

The present disclosure is directed to a novel pressure fixture assembly which incorporates an expansible bellows assembly in the place of expansion wedges to both increase the available space within the fixture for product to be bonded and to more precisely control the applied pressure through all phases of heating and cooling.

In the exemplary embodiments, the disclosure may reference stacked layers of expanded titanium mesh to be bonded for various industrial applications, as well as various materials for construction of the fixture frame and the bellows assembly. The pressure fixture as described herein should not be considered as limited to the particular end use materials or the exemplary fabrication materials to construct the fixture frame or bellows assembly.

The current method (thermal expansion bonding) requires a large amount of fixture volume for pressure generation. Regardless of fixture size, 45% or more, of available space inside the fixture is needed for a sufficient length (volume) of the high CTE wedges to provide enough thermal expansion pressure for bonding (See FIG. 1).

Due to the high cycle times (>16 hrs) for each furnace run, with a large fraction of the time dedicated to establishing vacuum, heating up, or cooling down, maximizing the number of stacked layer assemblies (packs) per furnace cycle is of high commercial value. However, under thermal expansion control, increasing the number of packs will reduce the bond quality.

An exemplary pressure fixture for diffusion bonding in accordance with the teachings of the present invention may include a pressure fixture frame and an expansible bellows assembly.

The fixture frame may in some embodiments be constructed out of graphite, consisting of graphite side wall plates, a top and bottom graphite plate each, and a graphite float plate. The float plate may include spaced channels along the length of the plate of appropriate width and depth. The dimensional size and thicknesses of the graphite fixture components may be adjusted as appropriate for the particular size and material of the components to be bonded.

The top and bottom plates include dovetail side edges which slide into dovetail slots in the sidewall, while the float plate is slidably movable within the interior column of the fixture frame between the top and bottom plates. The dovetails are designed to prevent stress concentration and failure when the fixture is pressurized. In use, alternating layers of the titanium layered packs (material to be bonded) and separating plates are stacked between the bottom plate and the float plate.

In the place of the prior art expansion wedges, the expansible bellows assembly is placed in an upper channel between the top of the float plate and bottom of the top plate.

The bellows assembly comprises a base plate and two cylindrical bellows symmetrically aligned on the base plate, each bellows comprising an extendable bellows wall and a cylindrical end cap. While two bellows are illustrated in the exemplary embodiment for a rectangular shaped fixture, a single bellows may be used for a smaller fixture, and it should be understood that other geometric configurations of bellows numbers and placements can be utilized for distributing pressure evenly throughout the fixture extent.

The bottom ends of the bellows walls are welded into circular grooves in the base plate while the top ends are welded to a wall surface or other structure of the end cap. The bellows end cap(s) may have a radial groove cut around the circumference, the height of which would be representative to the extension stroke required.

The bellows assembly may further include split collars (or sleeves) welded to the base plate and substantially encircling the entire circumference of the bellows. An inside lip of the collars protrudes into the radial groove. The groove and lip may serve as the compression/extension stops of the bellows.

The base plate is provided with a gas inlet bore to receive a high-pressure gas supply to inflate the bellows. The top of the base plate includes respective gas feed ports extending into the gas inlet bore from the upper surface of the base plate located in the center of the respective bellows rings. Pressurized gas (preferably Argon) travels through the inlet bore to the feed ports to pressurize and extend the bellows.

The bellows assembly components may be made of a high temperature metal, such as Inconel 625, which becomes pliable at temperature above 1000 °F. Once the material temperature reaches temperatures >1000 °F, the bellows can be extended.

The smaller (shorter) vertical height of the bellows package assembly allows a substantial additional number of stacked layer assemblies to be located within the fixture for bonding.

Accordingly, it can be seen that the bellows may be used to replace thermal expansion pressure altogether in which the fixture is packed loosely at room temperature.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is an illustration of a prior art pressure fixture assembly utilizing thermal expansion wedges to create pressure within the pressure fixture;

FIG. 2 is an illustration of a pressure fixture including a high temperature expansible bellows assembly in accordance with the teachings of the present disclosure;

FIG. 3 is a perspective view of a pressure fixture in accordance with the teachings of the present disclosure;

FIG. 4 is a plan view of a dual bellows assembly in accordance with the teachings of the present disclosure;

FIG. 5 is a cross-sectional view thereof taken along line 5-5 of FIG. 4;

FIG. 6 is a cross-sectional view thereof taken along line 6-6 of FIG. 4;

FIG. 7 is a plan view of a single bellows assembly in accordance with the teachings of the present disclosure; and

FIGS. 8 and 9 are graphical illustrations of comparative pressure profiles with the bellows (FIG. 8—present invention) and without the bellows (FIG. 9 prior art).

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

Unless otherwise specified, when referring to a numerical value, the term “about” is intended to be construed as including a range of values within +/−10% of the value being referenced.

The present disclosure is directed to a novel pressure fixture assembly for diffusion bonding which incorporates an expansible bellows assembly in the place of expansion wedges to both increase the available space within the fixture for product to be bonded and to more precisely control the applied pressure through all phases of heating and cooling in the diffusion bonding process.

In the exemplary embodiments to be discussed below, the disclosure may reference stacked layer assemblies of expanded titanium mesh which are to be diffusion bonded for various industrial applications, as well as various materials for construction of the fixture frame and the bellows assembly. The pressure fixture as described herein should not be considered as limited to the particular end use materials to be bonded or to the exemplary fabrication materials to construct the pressure fixture frame or bellows assembly.

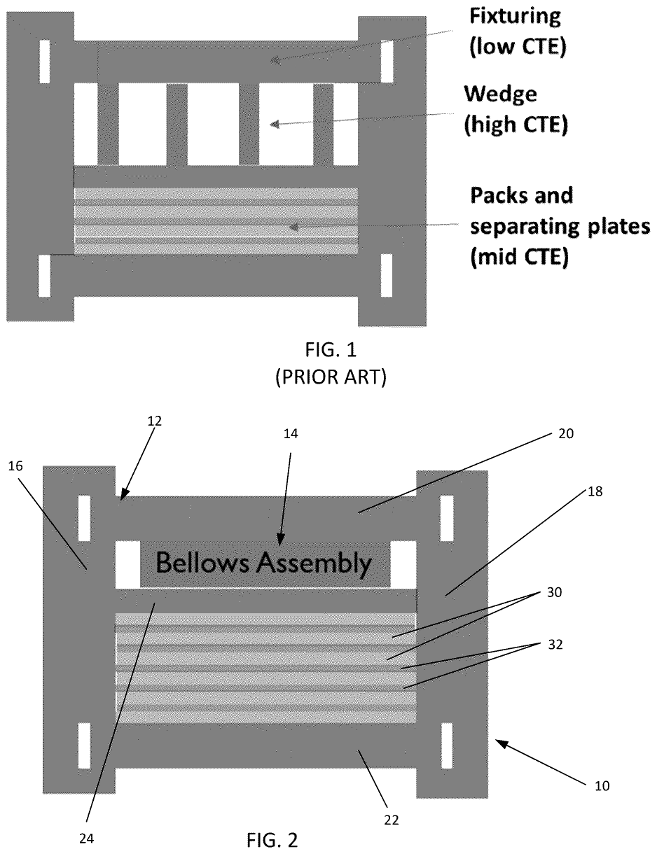

As noted above, the current method (thermal expansion bonding) requires a large amount of fixture volume for pressure generation. Regardless of fixture size, 45% or more, of available space inside the fixture is needed for a sufficient length (volume) of the high CTE wedges to provide enough thermal expansion pressure for bonding (See prior art FIG. 1).

Due to long heating, cooling and pressure cycle times (>16 hrs) for each furnace run, with a large fraction of the time dedicated to establishing vacuum, heating up, or cooling down, maximizing the number of stacked layer assemblies (bonding packs) per furnace cycle is of high commercial value. However, under thermal expansion control, increasing the number of packs is known to reduce the diffusion bond quality.

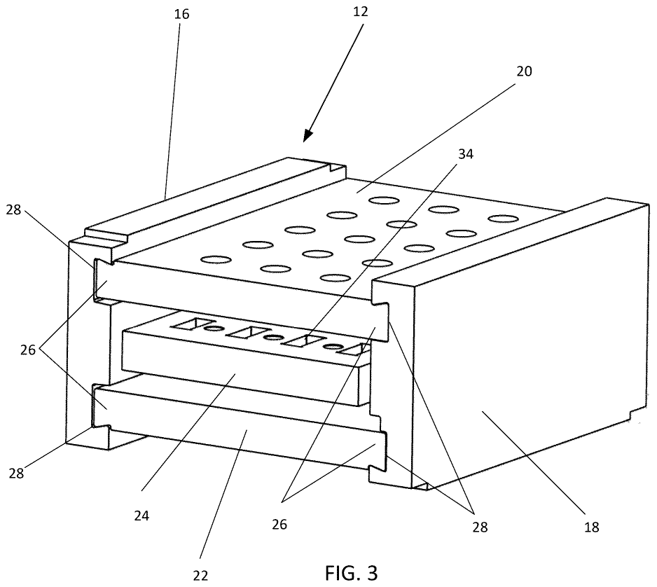

Referring now to FIGS. 2-7, an exemplary pressure fixture 10 for diffusion bonding in accordance with the teachings of the present invention comprises a pressure fixture frame 12 and an expansible bellows assembly 14.

The component plates of the pressure fixture frame 12 may in some embodiments be constructed out of graphite, comprising opposing side wall plates 16, 18, a top plate 20, a bottom plate 22, and a float plate 24 which is slidably movable within an interior column of the pressure fixture frame 12 defined between the top and bottom plates 20, 22 (See FIGS. 2 and 3).

As best seen in FIG. 3, the top and bottom plates 20, 22 may include dovetail shaped side edges or rails 26 which slide into corresponding dovetail shaped slots 28 in the sidewalls 16, 18 while the float plate 24 is slidably movable within the interior column of the fixture frame 12 between the top and bottom plates 20, 22. The interlocking dovetail rails 26 and slots 28 are designed to prevent stress concentration and failure when the fixture 10 is pressurized. In the illustrated example, alternating layers of the titanium layered packs 30 and separating plates 32 are stacked between the bottom plate 22 and the float plate 24.

The float plate 24 may include spaced channels 34 along the length of the float plate of appropriate width and depth. The dimensional size and thicknesses of the various graphite fixture components may be adjusted as appropriate for the particular size and material of the components to be bonded.

In the place of the prior art wedges, the present bellows assembly 14 is placed in the channel between the top of the float plate 24 and bottom of the top plate 20 (See FIGS. 2 and 4-7).

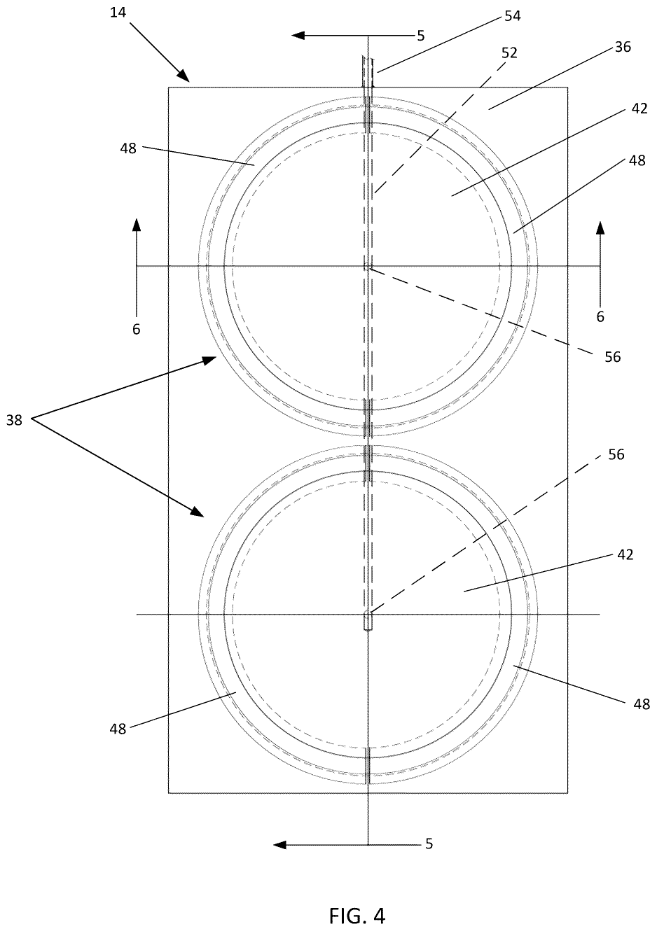

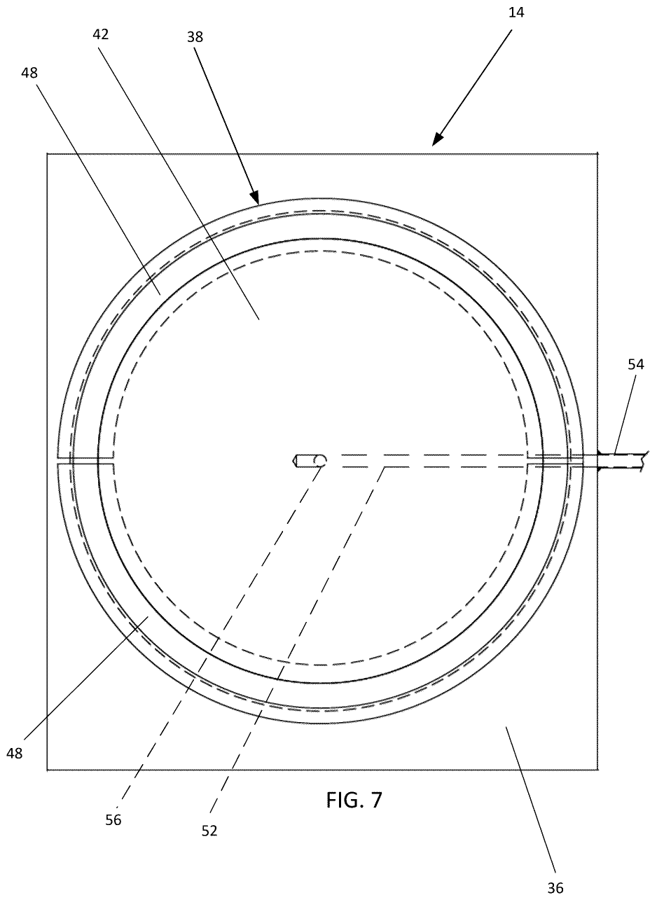

The bellows assembly 14 comprises a base plate 36 and at least one cylindrical bellows 38 disposed on the base plate 36. While two bellows 38 are illustrated in the exemplary embodiment in FIGS. 4-6 for use with a rectangular shaped fixture, a single bellows 38 may be used for a smaller square fixture (See FIG. 7). In FIGS. 4-6, the two bellows 38 are symmetrically aligned on the base plate 36 to evenly distribute pressure. It should also be understood that other geometric configurations of the shapes of the bellows 38 as well as the number and placement of the bellows 38 may be utilized for distributing pressure evenly throughout the fixture extent.

Each bellows 38 may comprise an extendable accordion-like bellows wall 40 and an end cap 42. The bellows 38 generally, and the bellows walls 40 end caps 42 may preferably be cylindrical for uniform pressure distribution, but other geometric shapes may also be possible.

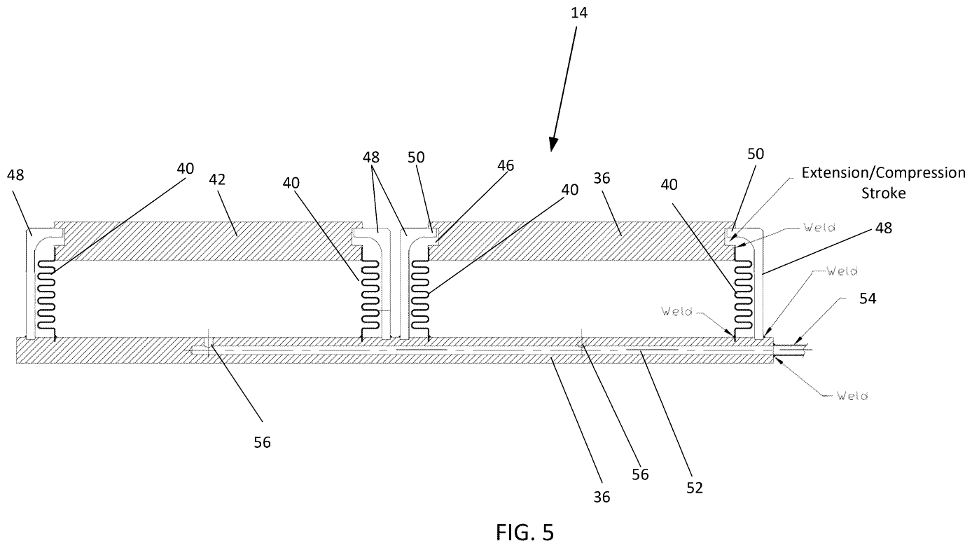

The bottom ends of the bellows walls 40 are secured (preferably welded) into a corresponding groove(s) 44 in the base plate 36 while the top ends thereof are secured (preferably welded) to a wall surface or other structure of the end cap 42. The bellows end cap(s) 42 may have a radial groove 46 cut around their circumference of their outwardly facing peripheral wall, the height of which is representative of the length of the extension stroke required in extension/compression (See FIG. 5).

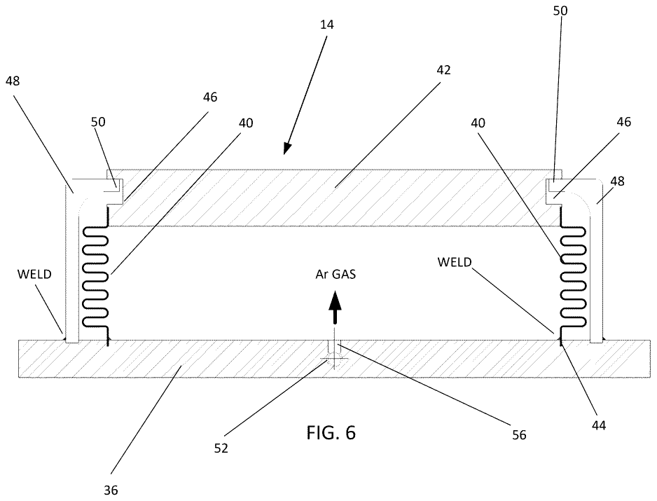

As best seen in FIGS. 5 and 6, there may be semi-circular split collars 48 (or sleeves) secured (preferably welded) to the base plate 36 and substantially encircling the entire circumference of the bellows 38 and having an inward turned lip 50 projecting inwardly into the radial groove 46 of the end cap 42. The radial groove 46 and projecting lip 50 may cooperate to serve as the compression/extension stops of the bellows 38, with even forces around the entire bellows circumference. The structural strength of the graphite floating plate 24 may need to be increased in various embodiments to compensate for independent bellows 38 and different bellows configurations.

The base plate 36 is provided with a gas inlet bore 52 to receive a gas supply from gas supply line 54 to inflate the bellows 38. The base plate 36 further includes respective gas feed ports 56 extending downwardly into the interior gas inlet bore 52 from the upper surface of the base plate 36 and located in the center of the respective bellows 38 (See FIG. 6). Pressurized argon gas travels through the inlet bore 52 to the feed ports 54 to pressurize and extend the bellows 38.

The components of the bellows assembly 14 may be made of a high temperature metal or alloy, such as Inconel 625, or others which become pliable at temperatures above 1000 °F. When the material temperature reaches and exceeds temperatures >1000 °F, the bellows 38 can be pressurized and extended. As can be seen in a quick comparison of FIGS. 1 and 2, the shorter vertical height of the bellows package assembly 14 allows a substantial additional number of stacked layer assemblies 30 to be located within the fixture frame 12 for bonding.

With the expansible bellows assembly 14, initial bonding of the packs 30 will occur due to compression from thermal expansion of the materials on heat up to 1550 °F. Subsequently, Argon gas pressure will be applied using the bellows to allow further compression and complete bonding.

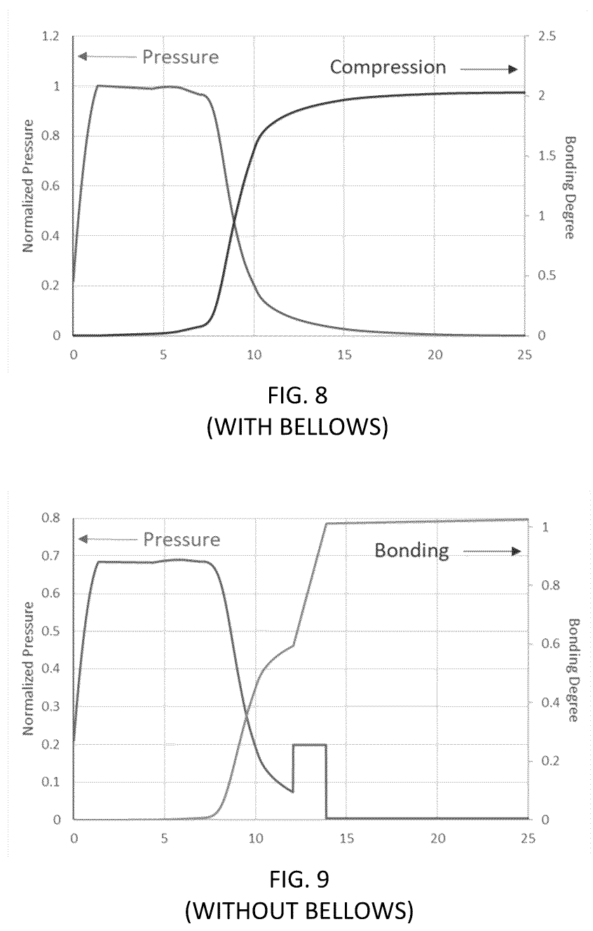

Comparative pressure profiles with the present expansible bellows assembly 14 (current invention) and without the bellows (prior art CTE wedges) are graphically illustrated in FIGS. 8 and 9.

It can therefore be appreciated that use of a high-temperature metal bellows allows higher levels of compression, and thus improved bonding, than from thermal expansion alone. The additional compression from the bellows fixture allows >50% more packs to be bonded per cycle as compared to use of the prior are thermal expansion wedges alone.

The present pressure fixture 10 and bellows assembly 14 may further be used in more complex pressure scenarios to improve certain material bonding characteristics and the quality of the end component parts. For example, the bellows assembly 14 may be used to apply a small amount of pressure (<25 psi down to 1 psi) as the bonding process cycles through the cool down phase. Applying pressure during cool down (especially from 1550 °F down to 1000 °F through the recrystallization temperature of titanium for example) can reduce potential deformation of the final parts.

The bellows assembly 14 may also be used to greatly reduce thermal expansion pressure at low temperatures. High pressure at temperatures <=1250 °F may result in creep-controlled deformation rather than diffusion-controlled deformation resulting in reduced bonding quality for the amount of expected total compression created by thermal expansion. By reducing the packing tightness of the fixture at room temperature, the pressure can be reduced at low temperatures, and the bellows may be used to create the expected compression at high temperature instead.

The bellows assembly 14 may be used to replace thermal expansion pressure altogether in which the fixture frame 12 is packed loosely at room temperature.

In some embodiments, the separating plates 32 may be coated with a barrier coating that has a different CTE from the titanium packs 30 or other metals to be bonded to prevent bonding of adjacent stacked layer assemblies.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A pressure fixture for diffusion bonding comprising:
a pressure fixture frame comprising
opposing side wall plates,
a top plate,
a bottom plate, and
a float plate,
wherein the float plate is slidably movable within an interior column of the pressure fixture frame defined between the top and bottom plates; and
an expansible bellows assembly comprising
a base plate,
at least one bellows disposed on the base plate,
said at least one bellows comprising an extendable bellows wall and an end cap, and
said base plate including a gas inlet bore configured to receive a pressurized gas supply to inflate the bellows.

2. The pressure fixture of claim 1 wherein the pressure fixture frame comprises graphite.

3. The pressure fixture of claim 1 wherein the top and bottom plates include dovetail side edges which are slidably received into corresponding dovetail slots in the opposing sidewall plates.

4. The pressure fixture of claim 2 wherein the top and bottom plates include dovetail side edges which are slidably received into corresponding dovetail slots in the opposing sidewall plates.

5. The pressure fixture of claim 1 wherein the float plate includes spaced channels.

6. The pressure fixture of claim 1 wherein the base plate and at least one cylindrical bellows comprises a metal or metal alloy which becomes pliable at >1000 °F.

7. The pressure fixture of claim 6 wherein said metal or metal alloy comprises Inconel 625.

8. The pressure fixture of claim 4 wherein the base plate and at least one cylindrical bellows comprises a metal or metal alloy which becomes pliable at >1000 °F.

9. The pressure fixture of claim 8 wherein said metal or metal alloy comprises Inconel 625.

10. The pressure fixture of claim 1 wherein the bellows is cylindrical and the expansible bellows assembly further comprises opposing semi-circular collars disposed on the base plate and encircling a circumference of the bellows,
said end cap including a radial groove around a peripheral outside edge thereof,
said opposing collars including an inward turned lip projecting into the radial groove,
wherein the radial groove and lip have predetermined dimensions configured to define upper and lower stop limits of a compressions stroke.

11. The pressure fixture of claim 4 wherein the bellows is cylindrical and the expansible bellows assembly further comprises opposing semi-circular collars disposed on the base plate and encircling a circumference of the bellows,
said end cap including a radial groove around a peripheral outside edge thereof,
said opposing collars including an inward turned lip projecting into the radial groove,
wherein the radial groove and lip have predetermined dimensions configured to define upper and lower stop limits of a compressions stroke.

12. The pressure fixture of claim 6 wherein the bellows is cylindrical and the expansible bellows assembly further comprises opposing semi-circular collars disposed on the base plate and encircling a circumference of the bellows,
said end cap including a radial groove around a peripheral outside edge thereof,
said opposing collars including an inward turned lip projecting into the radial groove,
wherein the radial groove and lip have predetermined dimensions configured to define upper and lower stop limits of a compressions stroke.

13. An expansible bellows assembly for a pressure fixture comprising:
a base plate,
at least one bellows disposed on the base plate,
said at least one bellows comprising an extendable bellows wall and an end cap, and
said base plate including a gas inlet bore configured to receive a pressurized gas supply to inflate the bellows.

14. The expansible bellows assembly of claim 13 wherein the base plate and at least one cylindrical bellows comprises a metal or metal alloy which becomes pliable at >1000 °F.

15. The expansible bellows assembly of claim 13 wherein the bellows is cylindrical, the bellows assembly further comprising:
opposing semi-circular collars disposed on the base plate and encircling a circumference of the bellows,
said end cap including a radial groove around a peripheral outside edge thereof,
said opposing collars including an inward turned lip projecting into the radial groove,
wherein the radial groove and lip have predetermined dimensions configured to define upper and lower stop limits of a compressions stroke.
